(19) United States
(12) Patent Application Publication
(10) Pub. No.: US 2004/0162752 A1
(43) Pub. Date: Aug. 19, 2004

(54) Retail quality function deployment

(76) Inventors: Kenneth E. Dean, Kirkwood, MO (US); Kurt R. Hofmeister, Okemos, MI (US)

Correspondence Address: Evan R. Sotiriou, Harness, Dickey & Pierce, P.L.C., Suite 400, 7700 Bonhomme, St. Louis, MO, 63105, US

(21) Appl. No.: 10/367,160

(22) Filed: Feb. 14, 2003

(51) Int. Cl. G06F 17/60

(52) U.S. Cl. 705/10

(57) ABSTRACT

A QFD process is provided for a retail environment. Displays for use in selecting and viewing data resulting from the QFD process allows for analysis of particular consumer requirements. A factor analysis is performed to define and confirm categories, thereby providing a consumer based interface for development of services in the retail environment. A structural equation model is developed and used to depict the interrelationships of the categories and the relative importance of those categories.

### FIELD OF THE INVENTION

The present invention relates generally to systems for product and service development, and more particularly to systems for providing a Quality Function Deployment (QFD) process to evaluate and analyze consumer data relating to performance of a retail selling environment.

### BACKGROUND OF THE INVENTION

Quality Function Deployment (QFD) generally provides a process for analyzing consumer data (e.g., focus group opinion information, questionnaire and survey responses, etc.) for use in product/service development. Essentially, the data is organized, for example, into product lists and matrices, for use in analyzing the data (e.g., characterizing and correlating information). The analyzed data is then used to define requirements relating to products and services development. Thus, the QFD process may be used to guide the development of new products and services by ensuring that the measurements that are developed are matched to those of the consumers purchasing or using the products or services of interest.

QFD was originally developed in Japan, and has since grown in use, including into many industries in the U.S., such as the automotive, durable goods and consumer electronics industries. The use of QFD is particularly widespread in the auto industry, where suppliers to automobile manufacturers are required to use QFD as a prerequisite to being certified as a supplier. QFD has also been used in the service industry, for example, in the hotel and restaurant industries.

Known QFD methods generally implement a team approach (i.e., cross-functional approach) to product development and integrate different development tools and best-practices approaches. Further, known approaches to providing a QFD process are based upon the particular application and development requirements. Generally, these approaches provide a QFD process for product and service management, for example, at the supplier level. Further, not only is the QFD use generally limited to product and service management, but the information is typically displayed in a manner that is difficult to use and interpret, thereby reducing the value of such information.

### SUMMARY OF THE INVENTION

The inventors of the present invention have perceived a need for extending the use of the QFD process, and in particular to adapting the QFD process to a retail environment and providing a display allowing for improved evaluation and analysis of gathered information. In general, embodiments of the present invention allow for using the QFD process in a retail environment or application and providing data displays for easily identifying consumer and/or customer requirements. Further, embodiments of the invention provide for analyzing gathered information (e.g., responses to survey questions) across various market segments and classifying the information to develop specific requirements for use in consumer communications and merchandising in the retail environment. Embodiments of the present invention also provide for determining the importance of specific customer requirements or attributes and categorizing them accordingly (e.g., categorize as a potential “wow” opportunity (exciter), an expected attribute (performance) or a minimum threshold attribute (basic)).

One embodiment of the present invention includes a method of providing a QFD process. The method includes determining consumer information based upon QFD data, performing a factor analysis of the consumer information, and categorizing the consumer information based upon the factor analysis. The consumer information may include one of consumer importance information and consumer performance information and the QFD data may include consumer rating data, with the consumer importance information and consumer performance information based upon the consumer rating data. The consumer rating data may include retailer performance ratings with the method further including classifying the consumer performance information based upon the retailer performance ratings.

The method may also include defining performance rating thresholds and/or a performance rating spread for use in classifying the consumer information. The consumer information may be arranged for display based upon the categorizing. For example, the consumer information may be arranged hierarchically for display based upon the categorized consumer information and/or may be arranged based upon a structural equation model.

In another embodiment of the present invention, a method of providing a QFD process includes applying the QFD process to a retail environment to allow for analysis of consumer information relating to the retail environment, analyzing the consumer information to determine patterns in the consumer information, and categorizing the consumer information based upon the determined patterns. The consumer information may include one of consumer importance information and consumer performance information and the analyzing may further include performing a statistical linking of the consumer information. Also, the consumer information may include consumer rating data with the method further including statistically linking the consumer information based upon patterns in the consumer rating data. The categorized consumer information may be displayed hierarchically and/or based upon a structural equation model.

In still another embodiment of the present invention, an interface for displaying data resulting from a QFD process includes a plurality of pictorial and textual representations of a determined set of categories of data, with the pictorial and textual representations selectable to provide data relating to a corresponding category in the set of categories. The data may be configured in a hierarchical arrangement and wherein the determined set of categories is defined based upon importance and/or performance ratings from the data. Also, the determined set of categories of data may be defined based upon a factor analysis. Further, linking representations depicting the relationship between the determined set of categories of data may be provided.

In yet another embodiment of the present invention a method of providing a QFD process includes receiving consumer information relating to a retail environment, categorizing the consumer information based upon a factor analysis, and providing the received consumer information arranged based upon the categorizing. The method may include displaying the consumer information in a hierarchical arrangement within each of the categories and/or displaying the consumer information showing the relationship between the categories.

Further areas of applicability of the present invention will become apparent from the detailed description provided hereinafter. It should be understood that the detailed description and specific examples, while indicating certain preferred embodiments of the invention, are intended for purposes of illustration only and are not intended to limit the scope of the invention.

### BRIEF DESCRIPTION OF THE DRAWINGS

Embodiments of the present invention will become more fully understood from the detailed description and the accompanying drawings, wherein:

FIG. 1 is a flow-chart of an exemplary QFD process;

FIG. 2 is one embodiment of an exemplary data matrix of the present invention resulting from a QFD process provided in a retail environment;

FIGS. 3A and 3B are screen shots of embodiments of displays of the present invention for displaying information from the QFD process provided in a retail environment;

FIG. 4 is a screen shot of one embodiment of a display of the present invention showing hierarchical arrangement of data resulting from the QFD process;

FIG. 5 is an exemplary data matrix selectable from the display of FIG. 4; and

FIG. 6 is one embodiment of a chart showing a summary of consumer information.

### DETAILED DESCRIPTION OF PREFERRED EMBODIMENTS

The following description of the preferred embodiments is merely exemplary in nature and is in no way intended to limit the invention, its application, or uses. Although the present invention is described in connection with using a QFD process with respect to particular services in a retail environment, it is not so limited, and the present invention may be implemented in connection with a QFD process for use with different retail environments.

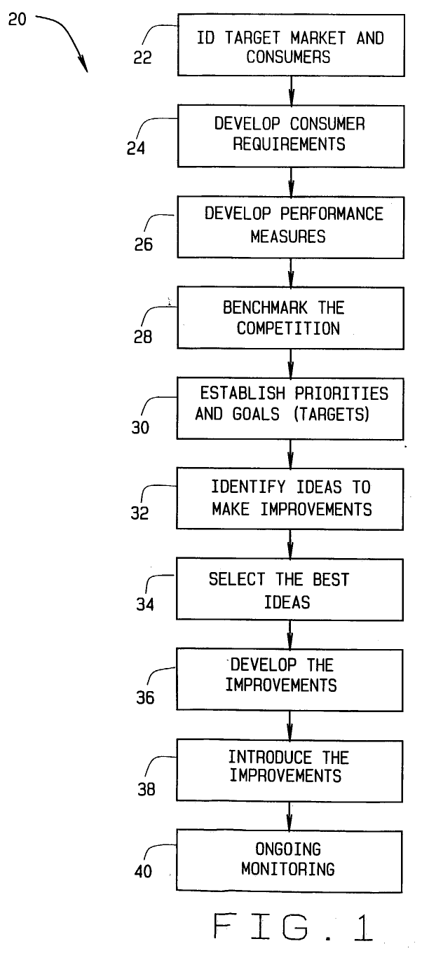

Before providing a detailed description of embodiments of the present invention for providing a QFD process for use in a retail environment and having improved displays for providing gathered information, a general description of an exemplary QFD process in connection with which embodiments of the present invention may be implemented will be provided. Specifically, and as shown in FIG. 1, a QFD process 20 begins at step 22 with identifying a target market and target consumers. Next, at step 24, consumer requirements are developed, including, for example, defining specific consumer requirements. This is provided using known QFD processes, including gathering data (i.e., QFD data) and creating lists of consumer requirements (e.g., gathered information), and thereafter creating matrices for evaluating gathered information. In particular, a determination of the specific features of products and/or requirements/expectations for services that provide more satisfaction than others is provided. Thereafter, at step 26, performance measures are developed based upon the developed consumer requirements. The competition is then benchmarked at step 28 based upon the developed performance measures.

Priorities and goals (i.e., targets) for product and/or service development are established at step 30. Next, specific ideas and/or areas, including particular product and/or service development methods are identified at step 32 as potential areas in which to make improvements. Thereafter, at step 34, specific ideas and/or areas are selected, and in particular the ideas and/or areas determined to be most beneficial for product and/or service development are selected. The improvements based upon the selected ideas and/or areas are then developed at step 36. The improvements are introduced and implemented at step 38. Finally, ongoing monitoring of the implemented improvements is provided at step 40. It should be appreciated that the steps provided in the QFD process 20 may be modified according to the specific development requirements or products/services involved.

Having described an exemplary QFD process 20, one embodiment of the present invention for providing a retail application of the QFD process 20 and displays for displaying gathered information will now be described. The description of the retail application of the QFD process 20 will be in connection with improving retail service relating to the sale of pet products. However, as should be appreciated by one skilled in the art, embodiments of the present invention may be implemented in connection with the QFD process 20 for providing different services in different areas, including, more generally, providing and/or developing improved services in the supermarket sub-segment, department/discount store sub-segment, gasoline/convenience store sub-segment and/or pet specialty store sub-segment, among others.

In general, various embodiments of the present invention provide for applying the QFD process 20 to a retail environment, including configuring the steps of the QFD process 20 for gathering, analyzing and displaying information relating to a retail QFD process. In the various configurations of the present invention for providing a retail QFD process, the following general steps are performed:

(1) Planning for the particular QFD process including identifying the specific retail environment of interest.

(2) Gathering QFD data including (i) performing qualitative information gathering (e.g., using a consumer focus group) for the identified retail environment of interest; and (ii) performing quantitative information gathering for the identified retail environment of interest (e.g., using questionnaires or surveys) to determine consumer information (e.g., consumer performance ratings).

(3) Performing analysis of the gathered information to identify areas for improvement in the retail environment of interest.

(4) Developing improvement strategies based upon the results of the analysis.

It should be noted that the terms data and information are used interchangeably herein and include, but are not limited to, any and all data, information, statistics, ratings, etc. relating to the various embodiments of the present invention described herein.

Embodiments of the present invention begin by defining an area of interest, for example by identifying categories targeted for improvement within the retail environment, such as, relating to the sale of pet products. This includes identifying relevant consumer targets/segments in the retail environment. Based upon the identified targets/segments, statements (e.g., benefit statements), which are to be rated by consumers are developed. For example, consumer focus groups are used to determine the wants/needs/expectations of consumers for the retail shopping experience in the targeted categories for use in developing the statements. In particular, consumer information (e.g., consumer opinions) for use in developing consumer requirements and performance measures is gathered. Specifically, information is gathered relating to consumer opinions that broadly define a particular area of interest and as described in more detail herein. For example, questions posed to consumers are more preferably directed to their perceptions about particular products and/or services in order to determine the important aspects or features (e.g., criteria) of products for consumers shopping in a particular environment (e.g., pet products for pet-owning customers relative to pet care shopping in a retail environment). Next, consumer ratings for each of the criteria are determined, for example, using surveys of representative samples of consumers. This includes determining the relative importance and perceived retailer performance for each of the identified aspects or features. Benefit statements in surveys may be used to assess the level of importance and perceived retailer performance.

Thereafter, analysis of the information gathered (e.g., responses to benefit statements) is performed to determine the stated and derived importance of each aspect or feature, which are then categorized using a factor analysis as described herein. A comparison may be made, for example, between different formats, such as between competing retailers, based upon these ratings. The categorized information is then displayed for use in determining areas or opportunities for improvement. A structural equation model is more preferably developed based upon the analyzed and categorized data for use in determining areas or opportunities for improvement. After determining the potential areas or opportunities of improvement (e.g., specific services that may be improved in the retail shopping area of interest), a determination is made as to specific strategies to be implemented.

Specifically, and referring to step 22 in FIG. 1, the scope of the QFD process 20 is defined, including, for example, identifying the particular areas of interest (e.g., services relating to dog food retail shopping) and potential competitors in the market. Once the scope of the QFD process 20 is defined, consumer information is gathered both qualitatively, for example, using consumer focus groups, and quantitatively, for example, using surveys of representative samples of consumers. In particular, and referring to step 24 in FIG. 1, focus groups are organized wherein consumers (e.g., pet owners) are questioned to identify their “root” needs and wants in the retail environment with respect to the particular area, such as pet care (i.e., determine voice of consumers and consumer requirements). Questions, preferably in the form of benefit statements to be rated, are developed based upon the particular retail services of interest to help identify the root needs and wants.

Next, questionnaires are used to determine consumers' importance ratings (i.e., rating from 1 to 10) across consumer voices (i.e., statements and requirements). Thereafter, and referring to step 26 in FIG. 1, performance ratings for particular retailers, which may include, for example, competitors, are determined. For example, determinations can be made as to which groups of pet owners account for a majority of sales with respect to particular pet foods or categories of pet foods. All of the responses from the questionnaires are then organized for use in analysis (i.e., gathered consumer information). More preferably, the gathered information is consolidated and organized into a core group of benefit statements, which are categorized. Determinations are made as to the importance of a particular attribute and the satisfaction level (e.g., performance level) for each attribute. Segmentation studies may be performed, for example, by a market research group, to identify this information by segment (e.g., class of buyer). For example, a determination can then be made as to which consumers purchase the products/services based upon price or other factors. It should be noted that this data can be provided with respect to different segments, for example, by retailer (e.g., benchmark the competition referenced as step 28 in FIG. 1).

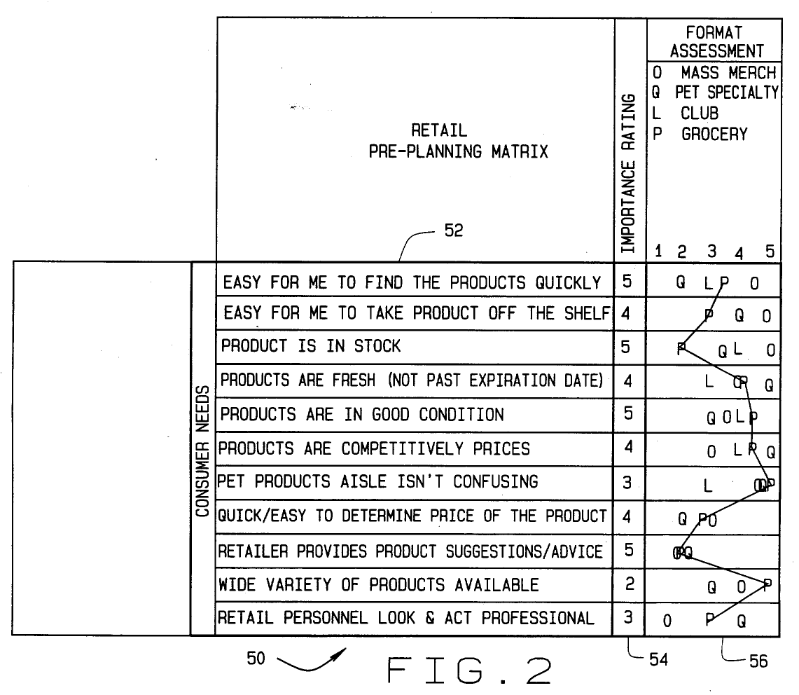

Using the gathered information (i.e., gathered consumer information), output data is generated, and in particular, QFD matrices are developed using a QFD program, such as, for example, QFD Designer, sold by QualSoft, LLC of Birmingham, Michigan. For example, and as shown in FIG. 2, a retail pre-planning matrix 50 may be provided based upon the gathered information. The matrices are used to identify opportunity areas for improvement referenced as step 32 in FIG. 1 (e.g., improve customer service). As shown, for each identified consumer need (i.e., requirement) provided in column 52, an importance rating (i.e., scale of 1-5) is provided in column 54 based upon the gathered information. A format assessment column 56 is also provided for displaying rating information for different formats (i.e., different categories of retailers), including, for example, mass merchandisers, pet specialty stores, clubs and grocery stores, regarding each of the consumer needs. Thus, a comparison can be made across different retailers. It should be noted that matrices may be generated based upon any specific identified consumer needs from the gathered information.

The gathered and organized information, which may be obtained as described generally in steps 24 and 26, is then categorized. This categorized information may be used, for example, to benchmark the competition referenced as step 28 and/or establish priorities and goals (i.e. targets) referenced as step 30. Specifically, in various embodiments of the present invention, a factor analysis is performed to identify response patterns to ensure that responses to specific questions are properly organized into categories. In one embodiment of the present invention, an initial or exploratory factor analysis is performed to group questions for consumers and thereafter a confirmatory factor analysis is performed to ensure that the responses are properly grouped. A re-grouping of questions and responses may be needed based upon a pattern analysis of the responses, and this process may be performed iteratively. The factor analysis may be performed using a predictive analysis program such as sold my SPSS, Inc. of Chicago, Ill. This provides for determining which attributes are more closely aligned or alike than other attributes, and allows for improved categorizing by determining benefit statements that are strongly related to a particular category and how the benefit statements are related to each other.

The factor analysis provides an averaged performance score for the benefit statements for each retailer. Using pattern analysis, a statistical linking of performance data to create categories (e.g., voice of the customer categories) is provided. Categories are defined and confirmed for use in identifying opportunities for improvement in particular areas. For example, the factor analysis may use average performance scores and standard deviations to determine trends in responses to benefit statements, and in particular performance ratings, in order to cluster the benefit statements into categories. Essentially, the factor analysis determines performance scores that co-vary together, indicating that the benefit statements may be related (e.g., consumers have similar thoughts or feelings when rating the benefit statements). Thus, the factor analysis results in categories of consumer voices, each of which have benefit statements associated therewith that are clustered, and the relationship of which has been analyzed and confirmed statistically.

Within each of the categories, the consumer attributes (e.g., voice statements) are classified as an Exciter, Performance or Basic attribute (i.e., KANO classification) using the QFD process 20. Specifically, the average performance rating of consumer responses are reviewed and analysis performed to determine and/or confirm the classification of a particular attribute as an Exciter, Performance or Basic attribute. In particular, the following guidelines are preferably used to classify the performance of each attribute:

(1) Basic attribute—less spread (e.g., less than 1.0) in performance rating data (i.e., between competitors) and a higher user defined best in class rating (e.g., at least 8.3).

(2) Performance attribute—greater spread (e.g., greater than 1.0) in performance rating data than Basic attribute and at least one competitor over a higher user defined best in class rating (e.g., at least 8.3).

(3) Exciter attribute—spread may be tight (e.g., less than 1.0) or loose (e.g., greater than 1.0) in performance rating data and a user defined best in class rating that is lower than for the Basic and Performance attributes (e. g., 6.5).

It should be noted that the amount of spread and the best in class threshold rating may be varied or adjusted depending upon particular requirements and/or may be predetermined. Also, the spread and rating range are each preferably on 1.0 to 10.0 scale. Further, a classification may be made as to each attribute with respect to performance compared to a competitive set (e.g., group of competitors). This may be used, for example to identify attributes in which improvement is possible or desirable, and those in which performance is at an acceptable or above average level, and improvement may or may not be desirable.

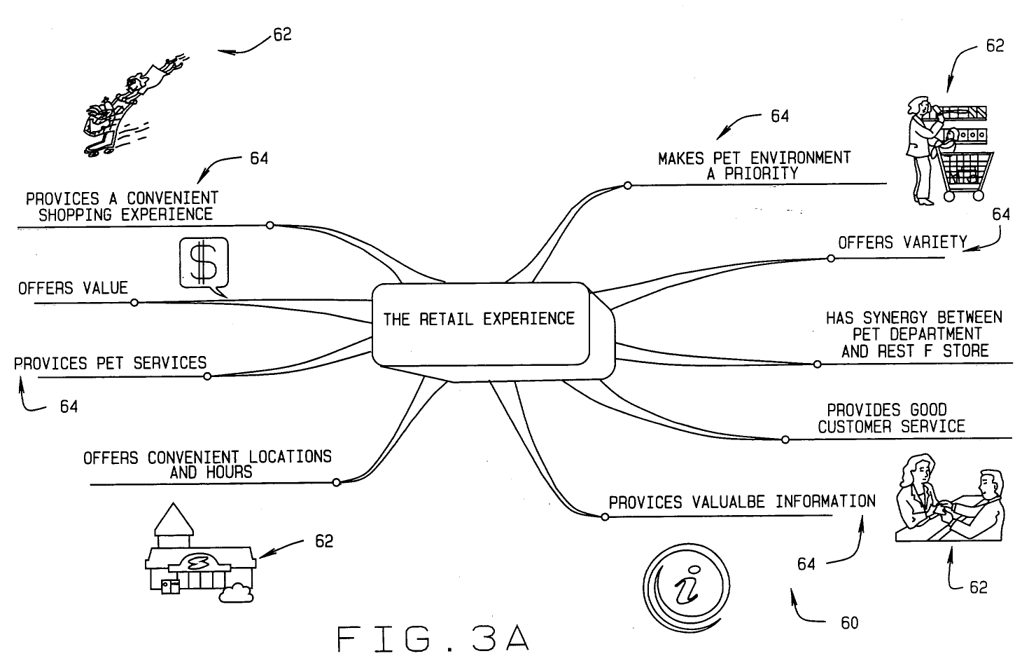

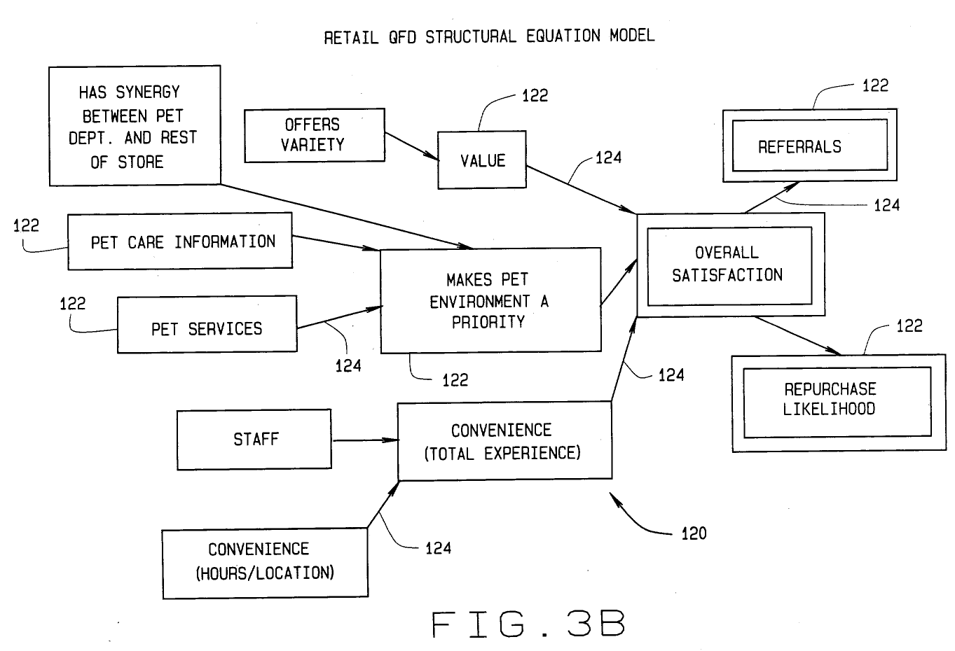

Having determined and confirmed groupings for the gathered information, the top consumer voices are then combined into top-level retail consumer voices (e.g., categories) and a display 60 according to one embodiment of the present invention may be provided as shown in FIG. 3A. As shown therein, the top-level retail consumer voices are represented using pictures or icons 62, and text 64 for each of the top-level retail consumer voices is provided in connection therewith. More preferably, the display 60 provides for user selection of a particular top-level retail consumer voice representation (e.g., using a computer mouse and clicking on the icon or text) to obtain specific information relating to that top-level retail consumer voice (i.e., linked to the information). The display 60 is preferably provided using a data management application, such as for example MindManager, sold by MindJet, LLC of San Francisco, Calif.

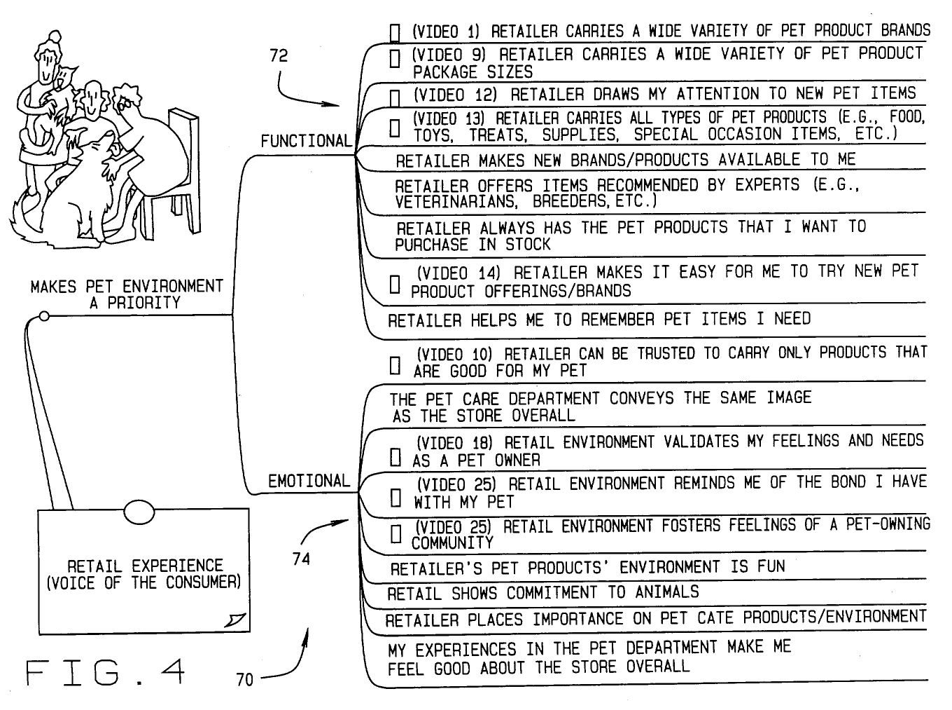

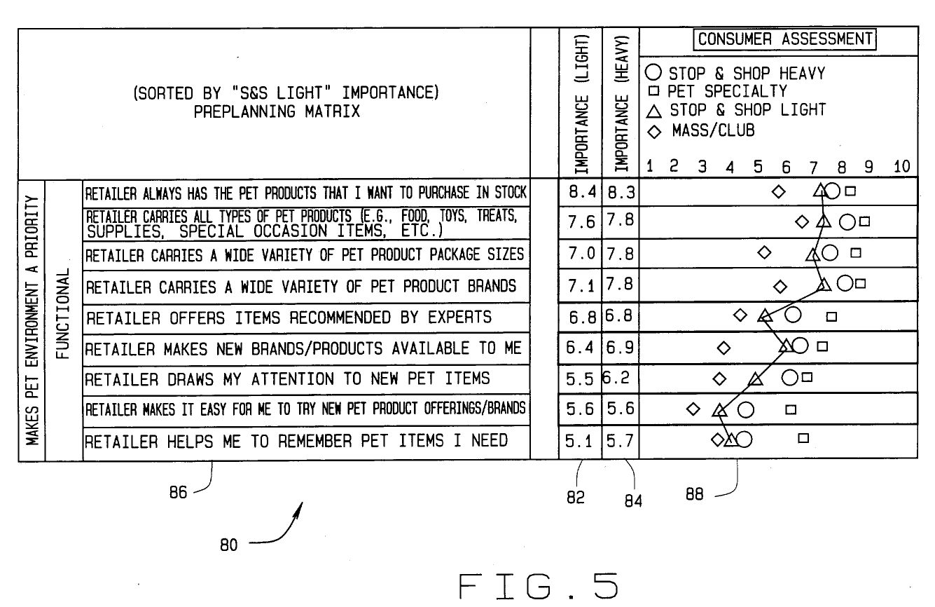

In operation, upon selecting a particular representation of a top-level retail consumer voice (i.e., icon 62 or text 64), a more detailed top-level retail consumer voice display 70 for the selected category (e.g., “Makes pet environment a priority”) is provided (i.e., linked to) as shown in FIG. 4. The information to be provided in each of these displays 70 is determined by the QFD process 20 and factor analysis described herein. The specific information displayed is preferably separated into sub-branches or sub-categories, for example, functional information 72 and emotional information 74. Again, the text identifying the functional and emotional information 72 and 74 may be selected to provide additional information, such as, for example, a video clip or specific responses to the particular selected statement. Additionally, the link may provide a display with a data matrix 80 as shown in FIG. 5. As shown therein, different levels of importance ratings are provided as Importance (Light) in column 82 and Importance (Heavy) in column 84 for each consumer requirement in column 86. Heavy and Light refer to consumers that shop often and those who do not, respectively. Again, a consumer assessment column 88 is provided to compare different formats (e.g., competitors). It should be noted that additional information configured in different columns may be provided as needed or desired.

In another embodiment of the present invention as shown in FIG. 3B, a display 120 is provided using a structural equation model. Such a model may be developed using, for example, LISERAL, a statistical software package available from Scientific Software International of Lincolnwood, Ill. This display 120 results from a factor analysis, as described herein, to determine the categories of consumer voices and to group the benefit statements thereunder, and a path analysis to determine the strength of the relationship between the categories (e.g., using statistical path analysis). Multiple regression methods may be implemented to determine the predictive value for each of the categories (e.g., how well a set of benefit statements predict an outcome such as repurchase likelihood) after performing a factor analysis. The structural equation model also considers errors/bias when performing analysis of the data. Further, non-recursive models may be developed (e.g., relationships in both directions between categories).

As shown in FIG. 3B, the top-level retail consumer voices, which identify the determined categories of responses from the factor analysis, are represented using text boxes 122 with arrows 124 linking and showing the relationship between categories. The thickness of a particular arrow 124 represents the strength of the relationship between the two categories linked by that arrow 124. For example, the thicker the arrow 124, the stronger the relationship between the two categories represented by the text boxes 122. Thus, the thicker the arrow 124, the better the predictive relationship between the categories such that movement in one category (e.g., changes in performance ratings) better predicts movement in the linked category. Thus, when viewing the display 120, a user can then determine the relative effect that a change in one category (e.g., proposed strategy to improve value) will have on another category (e.g., likely effect on overall satisfaction).

The text boxes 122 may be color coded to show areas that are stronger for a particular retailer and areas that are weaker for that retailer, making it easier to determine areas for improvement. Further, similar to the display 60, a user may select a text box 122 (e.g., using a computer mouse and clicking on the text box 122) to obtain additional information about that category (e.g., subcategories on a different screen showing a similar linking arrangement, video clips, specific benefit statements and/or performance scores relating to the category). Additionally, the linking of the text boxes and thickness of the arrows 124 may be changed of modified based upon further or additional analysis (e.g., iterative structural equation modeling analysis).

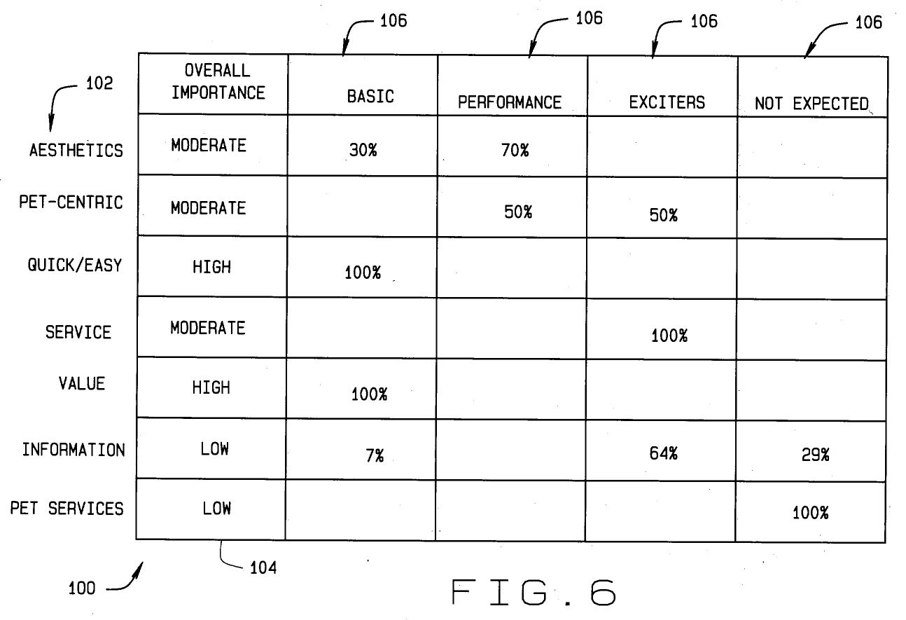

Based upon the information provided by the displays 60, 120 and matrices of embodiments of the present invention, analysis of gathered information may be provided, including, summaries of consumer voices and overall importance ratings and consumer satisfaction, as well as comparison with other formats, which may be competitive formats. Further, comparisons between different retail services provided for different products (e.g., shopping for cat versus dog products) may be provided. Linking the pet aisle with the rest of a particular store may also be provided. Gaps between heavy and light shoppers may be determined. Opportunity areas may be identified and satisfaction levels for different shoppers may be determined. For example, and as shown in FIG. 6, a consumer voice summary chart 100 of overall importance and voice classification may be provided based upon the gathered information and factor analysis. The categories 102 are determined based upon the QFD process 20 and factor analysis as described herein. The overall importance column 104 is based upon the average factor score from the factor analysis. The attribute columns 106 are based upon the factor analysis. The percentage values represent the percentage of consumers responding with the specific attribute to each of the categories 102. It should be noted that color coding of the boxes in the chart 100 may be provided to represent performance levels.

Thus, embodiments of the present invention provide a retail QFD process generally having the following steps:

(1) Identify categories targeted for improvement within retail environment (e.g., pet products, frozen foods, produce, etc.) and identify relevant consumer targets/segments.

(2) Conduct consumer focus groups to obtain consumer voices (e.g., general benefit statements) for retail shopping experience in targeted categories.

(3) Survey representative sample of consumers to determine relative importance and perceived retailer performance for each voice (e.g., each benefit statement), and determine performance on outcome variables (e.g., overall satisfaction, perception of value, etc.).

(4) Determine stated and derived importance of each voice, retailer performance ratings on voices and outcome variables, and KANO classifications (e.g., Exciter, Performance, Basic or Not Wanted) based on retailer performance ratings.

(5) Conduct factor analysis, which may be an iterative process to determine voice categories.

(6) Develop structural equation model to determine inter-relationships between factors and predictors of performance on outcome variables.

(7) Provide displays 60, 120 for use in determining improvement opportunities, which are based on factor analysis, structural equation modeling, performance ratings, and KANO classifications.

(8) Develop specific improvement strategies.

An example illustrating a QFD process 20 of the present invention will now be provided. However, this example is merely illustrative of one possible retail application of the present invention, and is not so limited. For example, although the example will be described in connection with a pet retail shopping environment and application of the QFD process 20 thereto, it may be used for other retail environments. For example, the QFD process 20 may be implemented for retail environments including frozen foods, produce, health and beauty, etc.

To begin, the targeted category for improvement within a retail environment is identified, such as, in this example, the pet retail shopping environment. Typically, this refers to identifying a particular retailer and may include a retailer having multiple locations (e.g., multiple supermarkets in a retailer chain). Within the identified category, a determination is then made as to the relevant consumer target/segments of interest. For example, the retail QFD process 20 may target light food shoppers (i.e., consumers that do not purchase much pet food, such as less than one hundred dollars a year) and heavy food shoppers (i.e., consumers that do purchase a lot of pet food, such as more than one hundred dollars a year) within the selected category, and compare the two groups. For example, an analysis may be performed using the QFD process 20 to identify areas to improve the retail pet shopping environment to increase sales to light food shoppers. With respect to heavy food shoppers, the QFD process 20 may be used to identify areas that may be used to encourage these individuals to purchase different varieties of pet products. Further, based upon the QFD process 20 a determination may be made as to how these different targeted groups view the pet retail shopping environment differently. It should be noted that the QFD process 20 may be modified to target different groups or additional groups, for example, consumers that shop at competitors or consumers that fall into a particular economic level.

After the retail category has been determined and the relevant consumer targets have been determined, one or more consumer focus groups are organized to obtain general consumer voices for the retail shopping experience and the targeted consumers. A representative group for the focus group is selected, for example by determining whether they satisfy certain criteria, such as whether they own a pet, where they buy their pet supplies primarily, etc. Thereafter, in the focus group, general questions are asked to the participants to determine particular wants and needs of the consumers. For example, questions such as the following may be asked: “What do you want when you buy pet food? What do you want when you walk into the store? What do you want when you walk down the pet aisle? What do you want when you load your pet food bag into the cart?” Also, the questions may be modified, for example to ask what the consumers need instead of or in addition to what they want. Based upon the responses from focus group, general voices, and in particular benefit statements are determined. Benefits statements are developed based upon a determination, for example, that consumers want or need a retail pet shopping environment that values pets, or that provides a wide variety of products, or that include particular store attributes (e.g., wide aisles or well lit).

After conducting the focus group, the benefit statements that are determined to be most relevant to the particular targeted consumers and environment, are provided in a survey for rating with the statements randomized. In particular, the benefit statements selected are provided in the survey questionnaire and might include questions to be rated, such as for example, the following:

My experiences in the pet department make me feel good about the store overall.

Retailer allows me to buy pet products in large/value sizes.

Retailer provides sales and promotions on pet items.

Retailer provides good value for the money on pet products.

Retailer helps me to get pet product information quickly.

Retailer is a credible source for advice on pet food.

Retailer offers pet adoption services.

Retailer provides one stop pet care services.

Retailer is located within close proximity to my home/work.

Retailer is open when I want to shop.

Retailer makes it easy for me to get in and out quickly.

Retailer draws my attention to new pet items.

Retailer makes it easy to locate the pet department.

Retailer carries a wide variety of pet product brands.

Retailer carries a wide variety of pet product package sizes.

Retailer pet environment is visually attractive.

Retailer shows commitment to animals.

Retail environment reminds me of the bond I have with my pet.

Retailer cares about pets and pet owners.

Retailer staff is friendly.

These questions are merely illustrative of those that may be asked and that are based upon the benefit statements generated from the focus group. The survey or questionnaire preferably provides these questions twice for rating by consumers. Consumers are preferably asked to rate the importance to them of these statements and to rate how well the particular retailer is doing with respect to each of these statements. Further, the consumer may be asked to rate how well a particular competitor is doing with respect to each of these benefit statements. It should be noted that no KANO questions are asked in the survey. For example, questions such as “How excited would you be if . . . and how upset would you be if [a particular attribute] were absent . . . ?” are not asked of the consumers.

The responses from the questionnaires or surveys are evaluated to determine stated and derived importance of each benefit statement or voice based upon the importance and performance ratings. A correlation is also determined with respect to outcome variables (e.g., overall sales, overall satisfaction, repurchase likelihood, likelihood to recommend, etc.) for the consumers. For example, a consumer may rate some benefit statement as unimportant, but on the performance side rate satisfaction low, indicating that there may be a discrepancy in the responses (i.e., consumer might care about this statement). Using the retailer performance ratings from the surveys, KANO classifications (e.g., basic, performance, and exciter attributes) are determined as described herein.

Thereafter, a factor analysis as described herein is performed that provides a statistical analysis of the responses to determine patterns in ratings indicating statements that are related, such that consumers are making the same considerations when evaluating those particular statements (e.g., cluster or categorize the benefit statements into groups). Based upon the statistical analysis, general consumer voices or categories are generated and names or titles for the categories are selected based upon the clustered statements. For example, if all the statements include the word priority, then a consumer voice or category may be defined as “makes pet environment a priority” as shown in FIGS. 3A and 3B and provided as one of the categories. Essentially, a determination is made statistically as to how the voices are matched or correlated to determine the categories. If there is any statistical ambiguity as to the voices, the process may be repeated in order to determine different correlations.

Once the categories have been determined, a display 60 or display 120 is created based upon the gathered information and factor analysis. With respect to the display 60, the categorized data is organized in a hierarchical arrangement as described herein. With respect to the display 120, the structural equation model shown therein further provides a visual indication as to how the various consumer voice categories are correlated. More specifically, the outcome variables (e.g., referrals, overall satisfaction, repurchase likelihood) are provided on the right side of the display 120 as shown in FIG. 3B, and the determined general categories (e.g., makes pet environment a priority, value, convenience, staff, pet services, pet care information, offers variety, has synergy between pet department and rest of store) are provided on the left side of the display 120 as shown in FIG. 3B. As described herein, a structural equation modeling analysis is performed to determine the relationship and correlation between the general consumer voice categories, which is adjusted and iteratively performed until confirmation of the model is provided.

Further, based upon the performance ratings of the gathered information from the surveys, the categories may be color coded to identify those areas at which a particular retailer is best and those areas at which a particular retailer is worst, which allows for a competitive assessment to highlight opportunities for improvement. Thereafter, a determination can be made as to prioritizing improvement options based upon the KANO classifications. For example, if a determination is made that a particular category is a basic, that is, consumers expect such attribute, and the retailer is doing poorly in that area, this is identified as a high priority area for potential improvement. Further, such prioritization can be based upon the overall importance of each of the categories, as shown in FIG. 6, and as determined by the average rated importance scores for each of the benefit statements set forth in the questionnaire.

Thus, the present invention provides a QFD process 20 resulting in improved visual displays 60 and 120 of qualitative data having categories determined based upon statistical analysis. The use of KANO classifications also allow for easier identification of opportunities for improvement. Further, performance data may be used to determine particular areas for improvement.

Embodiments of the present invention therefore provide a QFD process for use in a retail environment that includes displays adapted for analyzing and evaluating gathered information. A factor analysis is performed for classifying and confirming opportunities (e.g., opportunities for improvement in Exciter, Performance and Basic attributes). Using embodiments of the present invention, consumer data in a QFD process is grouped for easier evaluation and the particular categories are confirmed based upon specific consumer data. Embodiments of the present invention provide for benchmarking competition to tailor improvements and optimize the performance of services in a particular category in the retail environment, for example, services related to the retail sale of pet products. As such, a consumer-based template for category management is provided.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of providing a QFD process comprising:
determining consumer information based upon QFD data;
performing a factor analysis of the consumer information; and
categorizing the consumer information based upon the factor analysis.

2. The method according to claim 1 further comprising performing the factor analysis iteratively.

3. The method according to claim 1 wherein the consumer information comprises one of consumer importance information and consumer performance information.

4. The method according to claim 3 wherein the QFD data comprises consumer rating data, and the consumer importance information and consumer performance information is based upon the consumer rating data.

5. The method according to claim 4 wherein the consumer rating data comprises retailer performance ratings and further comprising classifying the consumer performance information based upon the retailer performance ratings.

6. The method according to claim 5 further comprising identifying the consumer performance information as one of an exciter, performance or basic attribute based upon the retailer performance ratings.

7. The method according to claim 6 further comprising defining performance rating thresholds for use in classifying the consumer information.

8. The method according to claim 6 further comprising defining a performance rating spread for use in classifying the consumer information.

9. The method according to claim 1 further comprising arranging the consumer information for display based upon the categorizing.

10. The method according to claim 9 wherein the arranging comprises arranging the consumer information hierarchically for display based upon the categorized consumer information.

11. The method according to claim 9 further comprising configuring the arranged consumer information based upon the relationship between the categories.

12. The method according to claim 9 further comprising identifying the relative strength of the relationships between the arranged categories.

13. The method according to claim 12 wherein the arranging comprises arranging the consumer information for display based upon a structural equation model.

14. The method according to claim 13 wherein the structural equation model is based upon a statistical path analysis to determine the strength of the relationship between the categories and the predictive value of each of the categories of consumer information relating to one or more other categories.

15. The method according to claim 4 wherein the factor analysis is based upon a statistical linking of averaged consumer rating data.

16. The method according to claim 1 wherein the consumer information is based upon QFD data relating to a retail environment.

17. A method of providing a QFD process comprising:
applying the QFD process to a retail environment to allow for analysis of consumer information relating to the retail environment;
analyzing the consumer information to determine patterns in the consumer information; and
categorizing the consumer information based upon the determined patterns.

18. The method according to claim 17 wherein the consumer information comprises one of consumer importance information and consumer performance information and the analyzing comprises performing a statistical linking of the consumer information.

19. The method according to claim 17 wherein the consumer information comprises consumer rating data and further comprising statistically linking the consumer information based upon patterns in the consumer rating data.

20. The method according to claim 17 further comprising displaying the categorized consumer information hierarchically.

21. The method according to claim 17 further comprising displaying the categorized consumer information based upon a structural equation model.

22. An improved method of categorizing consumer information based upon QFD data resulting from a QFD process, the improvement comprising:
performing a factor analysis of the consumer information to categorize the consumer information.

23. The method according to claim 22 wherein the consumer information comprises consumer importance rating information and consumer performance rating information and wherein the factor analysis comprises a statistical linking of the rating information to determine patterns in the rating information for categorizing the consumer information.

24. The method according to claim 23 further comprising configuring the categorized consumer information in a hierarchical arrangement.

25. The method according to claim 23 further comprising configuring the categorized consumer information based upon a structural equation model.

26. An interface for displaying data resulting from a QFD process comprising:
a plurality of pictorial and textual representations of a determined set of categories of data, the pictorial and textual representations selectable to provide data relating to a corresponding category in the set of categories.

27. The interface according to claim 26 wherein the data is configured in a hierarchical arrangement.

28. The interface according to claim 27 wherein the determined set of categories is defined based upon importance ratings from the data.

29. The interface according to claim 28 wherein the determined set of categories is defined based upon performance ratings from the data.

30. The interface according to claim 26 wherein the data comprises audio and video data.

31. The interface according to claim 26 wherein the determined set of categories of data is determined based upon a factor analysis.

32. The interface according to claim 26 wherein the data is arranged based upon a structural equation model.

33. The interface according to claim 32 further comprising linking representations depicting the relationship between determined set of categories of data.

34. The interface according to claim 33 wherein the linking representations are configured to show the relative strength between linked categories.

35. A QFD application for evaluating and analyzing consumer data comprising:
a user interface for displaying consumer data relating to a QFD process and arranged in categories, the arrangement based upon a factor analysis performed on the consumer data.

36. The QFD application according to claim 35 wherein the user interface comprises a plurality of selectable elements each representing a category of consumer data.

37. The QFD application according to claim 36 wherein the plurality of selectable elements comprises visual and textual components.

38. The QFD application according to claim 36 wherein the selectable elements are linked graphically depicting the relationship between the categories of data, with the links configured to show the relative strength between the linked categories.

39. A method of providing a QFD process comprising:
receiving consumer information relating to a retail environment;
categorizing the consumer information based upon a factor analysis;
providing the received consumer information arranged based upon the categorizing.

40. The method according to claim 39 further comprising displaying the consumer information in a hierarchical arrangement within each of the categories.

41. The method according to claim 39 further comprising displaying the consumer information showing the relationship between the categories.

42. The method according to claim 41 further comprising showing graphically the relative strength of the relationship between the categories.

43. The method according to claim 39 further comprising performing the factor analysis iteratively.

44. The method according to claim 39 further comprising providing a summary display of the consumer information based upon the factor analysis.

45. A display for displaying QFD data comprising:
a plurality of icons representing a determined set of categories of QFD data, the plurality of icons each separately selectable to provide QFD data relating to a corresponding category in the set of categories.

46. The display according to claim 45 wherein the plurality of icons represent a statistically determined set of categories of QFD data.

47. The display according to claim 46 wherein the QFD data is configured hierarchically within each of the categories.

48. The display according to claim 46 wherein the plurality of icons comprise a structural equation model.

49. The display according to claim 48 further comprising providing a visual indication in connection with each of the icons based upon a KANO classification.

50. The method according to claim 49 wherein the visual indication comprises color coding.

51. The method according to claim 46 wherein the plurality of icons represent a statistically determined set of categories of QFD data based upon a factor analysis.
